(19) United States
(12) Patent Application Publication
(10) Pub. No.: US 2021/0093429 A1
(43) Pub. Date: Apr. 1, 2021

(54) DUAL HEAD TEETH CLEANING APPLIANCE

(71) Applicant: LaVerne E. Nitz, Clearwater, FL (US)

(72) Inventor: LaVerne E. Nitz, Clearwater, FL (US)

(21) Appl. No.: 16/988,757

(22) Filed: Aug. 10, 2020

Related U.S. Application Data
(60) Provisional application No. 62/902,899, filed on Sep. 19, 2019.

(51) Int. Cl. A61C 17/22; A61C 17/26; A61H 13/00; A46B 15/00; A46B 13/02; A46B 9/04; A46B 9/00; A46B 13/00

(52) U.S. Cl. CPC A61C 17/222; A61H 2201/1671; A61C 17/225; A61C 17/26; A61C 17/224; A61H 13/00; A46B 15/0046; A46B 13/02; A46B 9/045; A46B 15/0044; A46B 9/005; A46B 13/008; A61H 2201/0153; A61H 2201/1207; A61C 17/221

(57) ABSTRACT

Described herein is an electronic dual-head teeth cleaning appliance that facilitates simultaneous front and rear surface cleaning of individual teeth. The teeth cleaning appliance is rechargeable, portable, lightweight, and electronic. In particular, the appliance is equipped with an ergonomic axially rotating handle, speed settings, and may have rubber bristles on the brush heads for massaging the gums during teeth cleaning. The bristles may have side-to-side or rotational action.

### CLAIM OF PRIORITY

This application claims priority to, and the benefit of, US provisional application with Ser. No. 62/902,899 filed on Sep. 19, 2019 with the title DUAL HEAD CLEANING APPLIANCE, the contents of which is incorporated by reference in its entirety.

### FIELD OF THE INVENTION

The inventive concept relates generally to an electromechanical toothbrush and other teeth cleaning appliances.

### BACKGROUND

Currently, there are a number of manual and electrical solutions for cleaning teeth. Manual toothbrushes are useful for surface-cleaning a user's teeth and gums but eventually become laden with bacteria and often are not used long enough at each brushing session to be effective. Electric and electronic toothbrushes are more effective in terms of time used and the cleaning of teeth and gums, but the brushing motion may still drive food particles to the user's gums or into empty spaces between the teeth. As a back-up, and as an additional appliance for cleaning, electric toothbrushes may include an electronic water flosser designed to be better for cleaning the gums than teeth; however, such a modification increases the cost of the appliance and increases the overall size of the appliance, thereby reducing ease of handheld use and portability of the teeth cleaning appliance. Therefore, there exists a need for a teeth cleaning appliance that addresses the abovementioned challenges and disadvantages of current teeth cleaning appliances and that simultaneously cleans both sides of each tooth.

### SUMMARY OF THE INVENTION

There is provided herein a teeth cleaning appliance that more effectively cleans a user's teeth and gums while being ergonomically configured for a user's hand. This appliance gently and simultaneously brushes the user's teeth on both the front and rear surfaces. In one embodiment, the teeth cleaning appliance simultaneously brushes the user's teeth with each downstroke of the bristles of the brushing heads on the upper teeth, or upward stroke of the bristles of the brushing heads on the lower teeth. In another embodiment, the teeth cleaning appliance simultaneously brushes the user's teeth with counterrotating brushes whereby the bristles brush downward on the upper teeth and upward on the lower teeth. Both exemplary embodiments prevent debris from getting pushed back into the gums and reduce the amount of brush abrasion, resulting in healthier gums and less gum recession over time. Furthermore, the present teeth cleaning appliance may be rechargeable and includes a removable and replaceable brushing section. In a related embodiment, to ensure sufficient cleaning time, the appliance may also be configured to have an internal timer set for each cleaning quadrants of a user's mouth.

One embodiment of the teeth cleaning appliance has an energy generating and transmitting module and handle assembly, the energy transmitting module including a housing having therein a motor and shaft crank arm assembly electrically connected to a power source, the housing including a power actuator located thereon configured to activate and control a speed of the motor. The shaft crank arm includes a drive portion that protrudes from the module housing at an end opposite the handle assembly and which imparts a circular or radial motion upon being actuated. The teeth brushing module in this embodiment is coupled to the housing member that includes an L-shaped crank arm that has a proximal end coupled to the drive portion of the shaft crank arm, the teeth brushing module including a dual-head brush assembly protruding from an upper surface of the brushing module and coupled to a distal end of the L-shaped crank arm. The dual-head brush assembly imparts a vertical movement in and out of the brushing module responsive to the L-shaped crank arm movement to provide a dual surface tooth cleansing motion on a user's teeth.

In one embodiment of the teeth cleaning appliance, the dual-head brush assembly within the brushing module includes a set of brush head members that is partially located within a brush assembly support frame in the housing member. The brush assembly support frame in this embodiment includes a support plate with a set of pivoting stopper arms located on distal ends of the support plate such that the stopper arms form a channel for vertical movement of the set of brush head members, each of the brush head members having spring-like extensions protruding therefrom that are both coupled at a distal end to a spring steel strip configured to provide a compression force on the spring-like extensions and against the stopper arms to widen a brush gap between the brush head members with each upward movement of the L-shaped crank arm.

A further embodiment of the teeth brushing module includes a pressure adjustment actuator configured to change the brush gap between the brush head members through a plurality of settings, a low setting for larger teeth wherein the brush head support frame is lowered within the brushing module and a high setting for narrower teeth wherein the brush head support frame is raised within the brushing module and protrudes further from the upper surface of the brushing module.

In a further embodiment of the teeth cleaning appliance, the brush head member includes rubber bristles on an upper end configured to massage and clean a user's gums.

In embodiments of the teeth cleaning appliance, the handle member may be configured to pivot or rotate axially. In embodiments of the teeth cleaning appliance, the teeth brushing module may include a series of fluid draining holes at a surface opposite the brush head members. In embodiments of the teeth cleaning appliance, the housing of the energy transmitting module may include a release button to decouple the teeth brushing module from the energy transmitting module.

In one embodiment of the teeth cleaning appliance, the dual-brush head assembly includes head brushes with each having bristles protruding laterally therefrom towards each other to perform a front and rear surface cleaning a user's tooth. In embodiments of the teeth cleaning appliance, the handle member may include a ribbed gripping surface.

In one embodiment of the teeth cleaning appliance, the housing and handle assembly has a motor and crank arm assembly electrically connected to a power source, the housing including a power actuator located thereon configured to activate and control a speed of the motor, wherein the shaft crank arm includes a drive portion that protrudes laterally from the housing, at an end opposite a handle member and which imparts an axial motion upon being actuated. The removable teeth brushing module is coupled to the housing member that includes a crank arm linkage assembly that has a proximal end coupled to the drive portion of the shaft crank arm, the teeth brushing module including a brush assembly protruding from an upper surface of the brushing module and coupled to a distal end of the crank arm linkage assembly, wherein the brush assembly imparts a vertical movement in and out of the brushing module responsive to the linkage assembly movement to provide a dual surface tooth cleansing motion on a user's teeth.

In one embodiment of the teeth cleaning appliance, the teeth brushing module includes a pressure adjustment actuator configured to change a brush gap between brush head members of the brush assembly through a plurality of settings, a low setting for larger teeth wherein a brush head support frame supporting the brush assembly is lowered within the brushing module and a high setting for narrower teeth wherein the brush head support frame is raised within the brushing module and the brush assembly protrudes further from the upper surface of the brushing module.

In one embodiment of the teeth cleaning appliance, the brush assembly includes rubber bristles on an upper end protruding from the brushing module configured to massage and clean a user's gums. In embodiments of the teeth cleaning appliance, the teeth brushing module may include a series of fluid draining holes at a surface opposite the brush assembly. In embodiments of the teeth cleaning appliance, the housing and handle assembly may include a charging port for charging the power source. In one embodiment of the teeth cleaning appliance, the brush assembly is selected from the group consisting of a set of elongate brush heads, a set of rotary-style bristle brush heads, and a set of elongate sponge cleaning heads.

In embodiments of the teeth cleaning appliance, the handle and housing assembly may include an LED light on an upper surface co-planar with the brush assembly. In embodiments of the teeth cleaning appliance, the handle and housing assembly may include an electronic module with a microcontroller to provide time of use alert with a haptic vibration appliance or an LED light.

One embodiment of the inventive concept includes a method of cleaning a front and rear surfaces simultaneously of a user's teeth. This method provides a set of opposing brush head members having a plurality of bristles that are directed laterally and inward to form a cleaning zone about the user's teeth. This method involves moving the opposing brush members in a vertical up and down direction using a motive force provided by a teeth cleaning mechanism coupled to the brush head members so as to clean a front and back surface of a user's teeth simultaneously. In one embodiment of the inventive concept, the method further includes the step of massaging and cleaning a set of gums using rubber bristles at an upper end of each of the brush head members during the vertical up and down movement. In one embodiment of the inventive concept, the method further includes the step of adjusting a pressure of the opposing brush head members about the user's teeth by changing a brush gap of the cleaning zone between the brush head members through a plurality of settings, a low setting for larger teeth wherein a brush head support frame is lowered within a brushing module and a high setting for narrower teeth wherein the brush head support frame is raised within the brushing module so as to protrude further up from an upper surface of the brushing module.

One embodiment of the teeth cleaning appliance includes an energy generating and transmitting module and handle assembly for rotary brushes. In this embodiment, the energy transmitting module includes a housing having therein a motor and driveshaft assembly electrically connected to a power source, the housing including a power actuator located thereon configured to activate and control a speed of the motor, wherein the driveshaft includes a proximal drive portion that extends from the motor at an end opposite the handle assembly and which imparts a circular or radial motion upon being actuated. A teeth brushing module is coupled to the housing member. A rotatable drive gear member is disposed within the teeth brushing module, the drive gear member axially coupled to the proximal drive portion of the driveshaft. A first brush driveshaft and a second brush driveshaft are disposed parallel and offset to the driveshaft and extending from the teeth brushing module opposite the handle assembly. A gear assembly in this embodiment includes the rotatable drive gear member, a rotatable first brush gear member, a rotatable second brush gear member, and at least one intermediary gear member, each gear member co-planarly aligned and interlocking at least one other gear member within the gear assembly. The gear assemblies are so disposed so the first and second brush driveshafts counterrotate. A distal end of the first extendable brush driveshaft is coupled to the rotatable first brush gear member and a distal end of the second brush driveshaft is coupled to the rotatable second brush gear member. A first rotatable brush member is coupled to a proximal end of the first brush driveshaft and a second brush member is coupled to a proximal end of the second brush driveshaft. A plurality of bristle members circumscribes the first and second brush members, wherein the drive gear member, when rotated, imparts through the gear assembly a counterrotating movement of the first and second brush members to provide a dual surfaced, rotational tooth cleansing motion on a user's teeth.

In one embodiment of the teeth cleaning appliance, the drive gear member is slidably coupled to the driveshaft, the drive gear member of the gear assembly coupled to an interior connector assembly of a slider assembly. An exterior portion of the slider assembly is disposed through a slot portion disposed through the brushing module, the slot portion parallel to the drive portion of the crank shaft arm, the slider assembly designed to allow a user to at least partially extend and retract the first and second brush driveshaft from the teeth brushing module.

In one embodiment of the teeth cleaning appliance, a U-shaped cheek protector assembly is slidably coupled to the brushing module, the aperture portion of the U-shaped cheek protector proximally faced. The first and second brush shaft crank member is disposed longitudinally and laterally substantially within the aperture portion and parallel to a first stem portion and a second stem portion of the U-shaped cheek protector, the U-shaped cheek protector coupled at the base portion of the U-shaped cheek protector to the exterior portion of the slider assembly and designed to extend and retract jointly with the first and second brush driveshafts.

One embodiment of the inventive concept includes a method of simultaneously cleaning the front and rear surfaces of a user's teeth that provides a set of opposing brush head members having a plurality of bristles circumscribing the brush head members to form a cleaning zone about the user's teeth. In this embodiment, counterrotating the opposing brush members in clockwise and counterclockwise directions using a motive force provided by a teeth cleaning mechanism allows the brush head members to clean a front and back surface of a user's teeth simultaneously, the plurality of bristles designed to move materials away from the user's gumlines. In one example embodiment, a set of steel shafts, or other flexible but strong material, allow the user to obtain the flexibility desired or needed.

The inventive concept advantageously addresses the aforementioned deficiencies by providing a portable electronic dual-head toothbrush which provides a way for users to effectively clean both sides of each tooth at the same time. In various embodiments, the appliance includes multiple speed and pressure/profile settings to accommodate user preferences.

The inventive concept now will be described more fully hereinafter with reference to the accompanying drawings, which are intended to be read in conjunction with both this summary, the detailed description, and any preferred and/or particular embodiments specifically discussed or otherwise disclosed. This inventive concept may, however, be embodied in many different forms and should not be construed as limited to the embodiments set forth herein; rather, these embodiments are provided by way of illustration only and so that this disclosure will be thorough, complete, and will fully convey the full scope of the inventive concept to those skilled in the art.

### BRIEF DESCRIPTION OF THE DRAWINGS

FIGS. 1A-1D illustrate a perspective view, a left side perspective view of a teeth cleaning appliance and views of a plurality of drain holes and a charging port of the teeth cleaning appliance or appliance according to the teachings of the inventive concept.

FIGS. 2A-2D illustrate a front view and exploded views of components of the teeth cleaning appliance.

FIGS. 3A-3B illustrate right side views of a brushing technique of a pair of brush heads in the brushing component of the teeth cleaning appliance.

FIGS. 4A-4C illustrate a pressure adjustment mechanism and a low and a high setting of the pressure adjustment mechanism of the teeth cleaning appliance.

FIG. 5 illustrates a front view of the teeth cleaning appliance.

FIG. 6 illustrates a back view of the teeth cleaning appliance.

FIG. 7 illustrates a right-side view of the teeth cleaning appliance.

FIG. 8 illustrates a left side view of the teeth cleaning appliance.

FIG. 9 illustrates a top view of the teeth cleaning appliance.

FIG. 10 illustrates a bottom view of the teeth cleaning appliance.

FIG. 11 illustrates a perspective view of the teeth cleaning appliance.

FIG. 12 illustrates a perspective view of the teeth cleaning appliance with rotatable brush configuration.

FIG. 13 illustrates the interior view of the teeth cleaning appliance with rotatable brush configuration.

FIG. 14 illustrates a right-side view of the teeth cleaning appliance with rotatable brush configuration.

FIG. 15 illustrates a left side view of the teeth cleaning appliance with rotatable brush configuration.

FIG. 16 illustrates a front view of the teeth cleaning appliance with rotating brush configuration.

FIG. 17 illustrates a back view of the teeth cleaning appliance with rotatable brush configuration.

FIG. 18 illustrates a top view of the teeth cleaning appliance with rotatable brush configuration.

FIG. 19 illustrates an interior view of the teeth cleaning appliance with rotatable brush configuration.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes. In various embodiments of the inventive concept, there is provided an electronic dual-head teeth cleaning appliance having in one embodiment a rechargeable battery and an axially rotatable handle for ease of use as well as simultaneous cleaning of a front and a rear surface of a user's teeth.

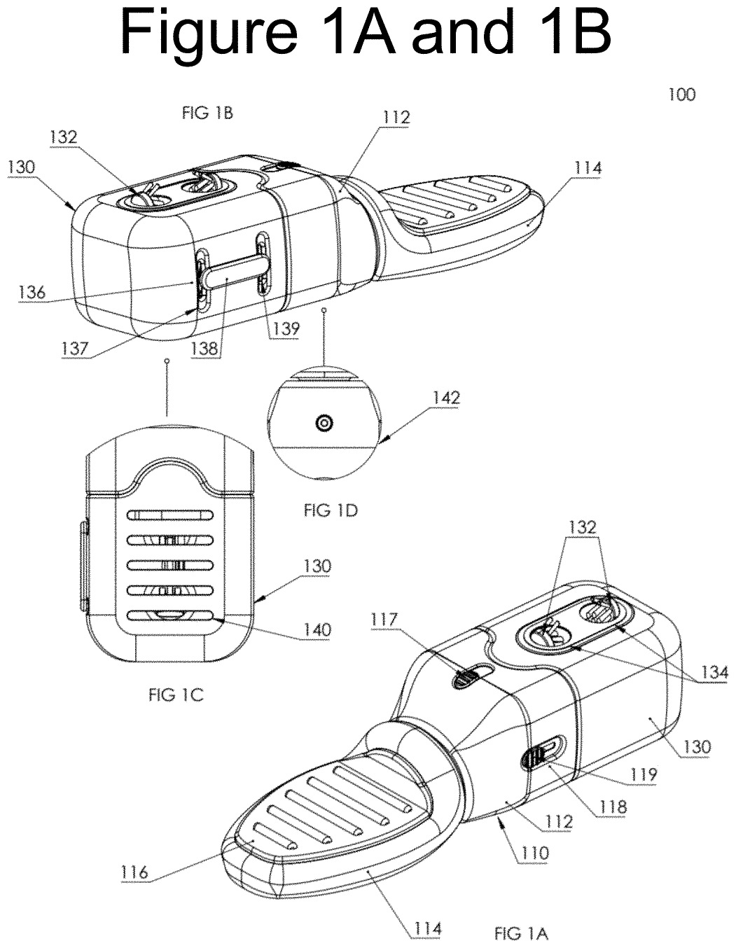

Referring now to the figures, FIGS. 1A-1D illustrate a perspective view, a left side perspective view of teeth cleaning appliance 100 and views of a plurality of drain holes 140 for draining fluids and a charging port 142 of a teeth cleaning appliance according to the teachings of the inventive concept. In this example embodiment, cleaning appliance 100 includes a housing and handle assembly 110 having a housing 112 and a handle 114 extending laterally from and coupled to housing 112. Handle 114 includes a series of ribs or rubber padding 116 to enhance gripping and as will be discussed later, handle 114 is rotatable in an axial direction to enhance ease of use by the user. Cleaning appliance 100 further includes a teeth brushing module 130 coupled laterally to housing 112. In this example embodiment, module 130 includes a set of brush heads 132 protruding from holes 134 on an upper surface of module 130. Referring now to FIG. 1B there is shown a brush pressure adjustment lever 136 that slides up and down along a track 139 in housing 130. A settings display 137 is located adjacent lever 136. In addition, the housing of the energy transmitting module and housing assembly 110 includes a release button 117 to decouple the teeth brushing module 130 from the energy transmitting module 110.

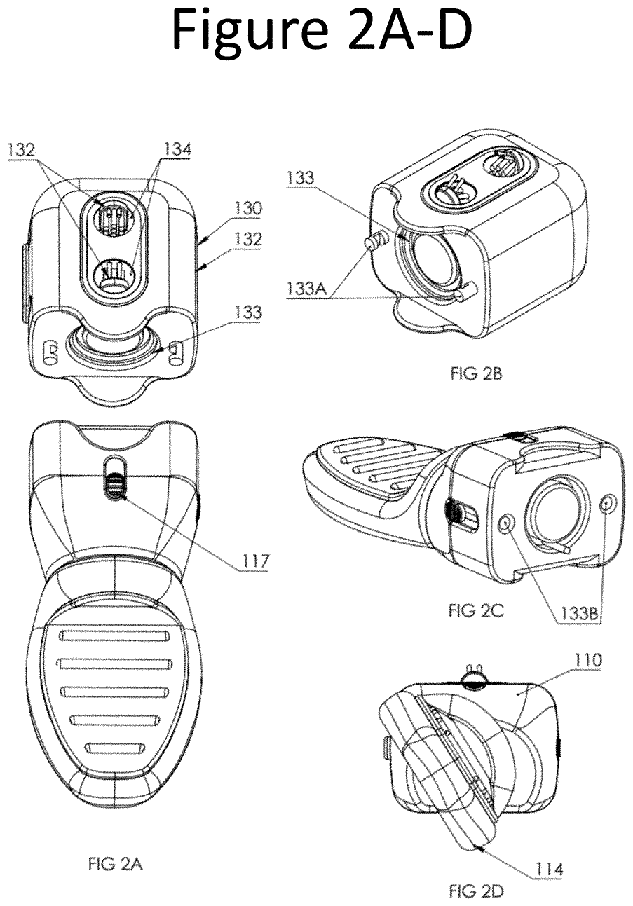

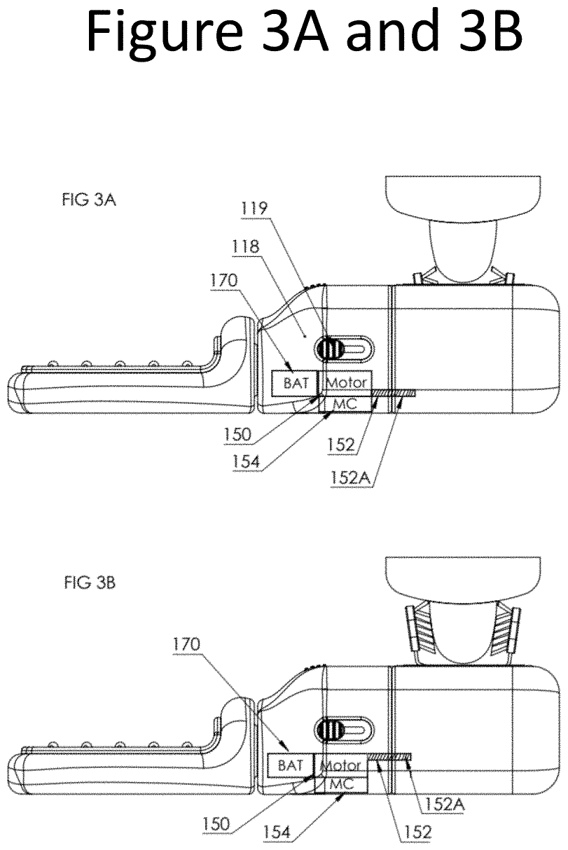

Referring now to FIGS. 2A-2D and FIGS. 3A-3B, which illustrate a front view and exploded views, as well as internal views, of components of teeth cleaning appliance 100. In particular assembly 110 is an energy generating and transmitting module and handle assembly, which includes housing 112 having therein a motor 150 and shaft crank arm assembly 152 electrically connected to a power source 170, the housing including a power actuator 118 with a speed indicator 119 located thereon to activate and control a speed of the motor 150. Shaft crank arm assembly 152 includes a drive portion 152A that protrudes from module housing 112 at an end opposite handle 114 and which imparts a circular or radial motion upon being actuated. Module assembly 110 includes a battery 170 as a power source as well as a microcontroller 154 electrically connected to battery 170 and motor 150 for controlling shaft crank arm assembly 152. Microcontroller 154 also provides time of use capabilities for a user as a well as haptic alerts. In a related embodiment, module 110 includes an LED light to illuminate a user's teeth and is electrically coupled to the battery 170 and controller 154. A charging port 142 is included that is coupled to battery 170 for charging.

Appliance 100 includes a removable teeth brushing module 130 coupled to housing member 110 that includes an L-shaped crank arm assembly 160 that has a proximal end coupled to drive portion 152A of shaft crank arm 152, with teeth brushing module including a dual-head brush assembly 132 protruding from an upper surface of the brushing module via apertures 134 which is coupled to a distal end 162A of L-shaped crank arm 162. Dual-head brush assembly 132 imparts a vertical movement, as displayed by the arrows, in and out of the brushing module 130 responsive to L-shaped crank arm 162 movement to provide a dual surface tooth cleansing motion on a user's teeth.

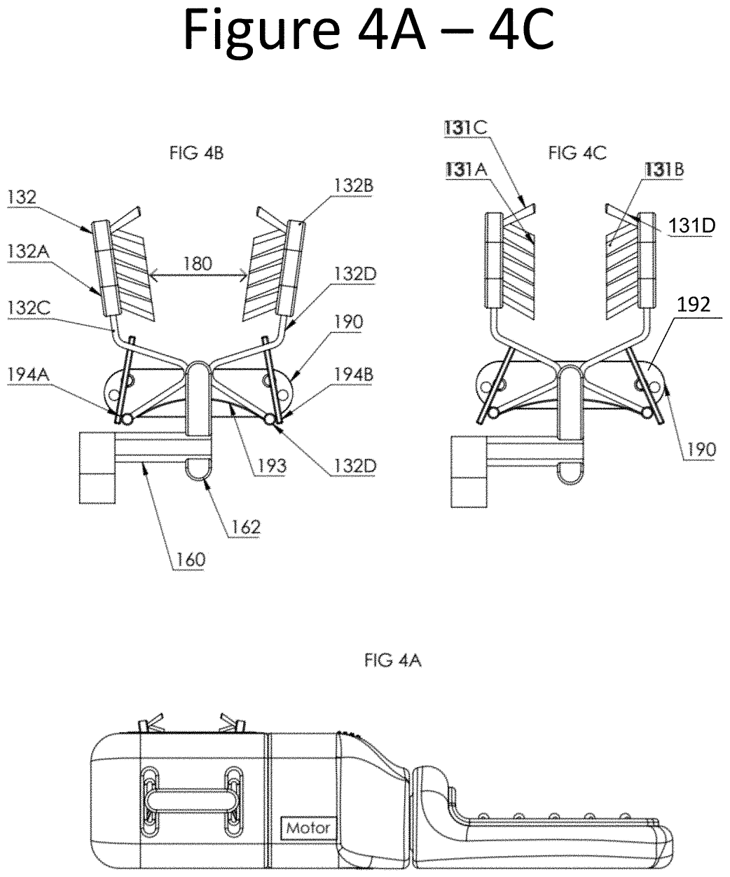

In this example embodiment, referring briefly to FIGS. 4A-4B, dual-head brush assembly 132 within brushing module 130 includes a set of brush head members 132A and 132B partially located within a brush assembly support frame 190 in the housing member. Brush assembly support frame 190 includes a support plate 192 with a set of pivoting stopper arms 194A/194B located on distal ends of support plate 192 such that stopper arms 194A/194B form a channel for vertical movement of the set of brush head members 132A-132B, each of the brush head members having spring-like extensions 132C/132D protruding therefrom that are both coupled at a distal end to a spring steel strip 193, the spring steel strip provides a compression force on spring-like extensions 132C/132D and against the stopper arms to widen a brush gap 180 between the brush head members 132A-132B with each upward movement of the L-shaped crank arm 162. Dual-brush head assembly 132 includes head brushes 132A/132B with each having bristles 131A/131B protruding laterally therefrom towards each other to form a cleaning zone and perform a front and rear surface cleaning a user's tooth.

In operation, teeth cleaning appliance 100 cleans the front and rear surfaces simultaneously of a user's teeth by providing a set of opposing brush head members 132A/132B having a plurality of bristles that are directed laterally and inward to form a cleaning zone about the user's teeth. Thereafter, moving the opposing brush members in a vertical up and down direction using a motive force provided by a teeth cleaning mechanism coupled to the brush head members so as to clean a front and back surface of a user's teeth simultaneously. The cleaning operation also includes massaging and cleaning a set of gums using rubber bristles 131C/131D at an upper end of each of the brush head members 132A/132B during the vertical up and down movement.

Referring again to FIGS. 4A-4C, there is illustrated a pressure adjustment mechanism and a low setting (FIG. 4B) and a high setting (FIG. 4C) of the pressure adjustment mechanism of the teeth cleaning appliance. In this example embodiment, teeth brushing module 130 includes a pressure adjustment actuator 138 that changes the brush gap 180 between the brush head members 132A/132B through a plurality of settings 137, a low setting for larger teeth wherein the brush head support frame 190 is lowered within the brushing module and a high setting for narrower teeth wherein the brush head support frame 190 is raised within the brushing module and protrudes further from the upper surface of the brushing module 130.

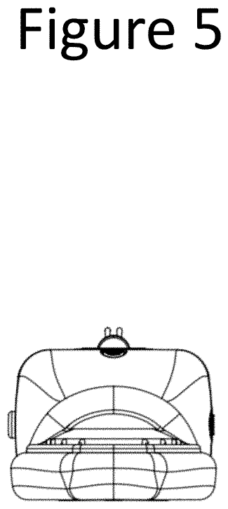

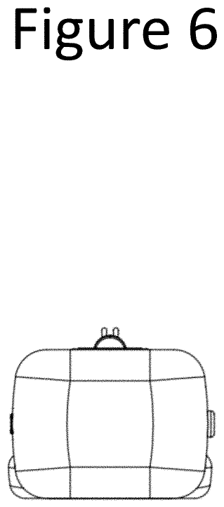

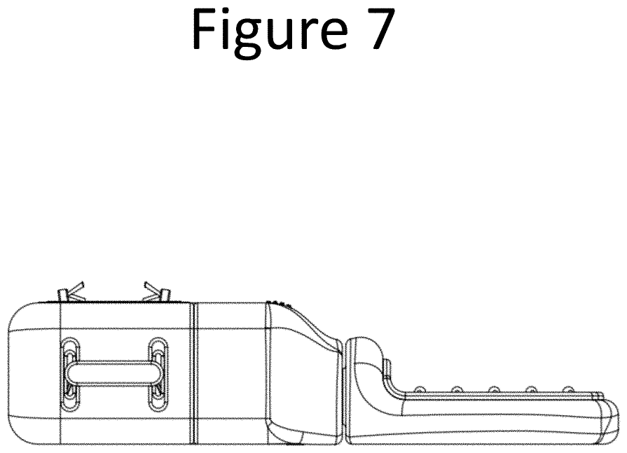

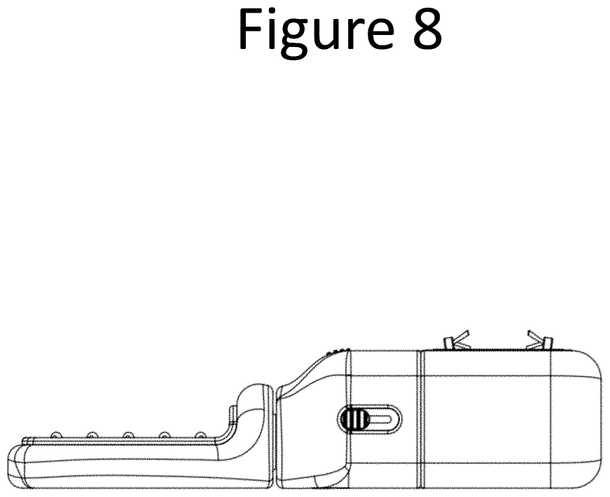

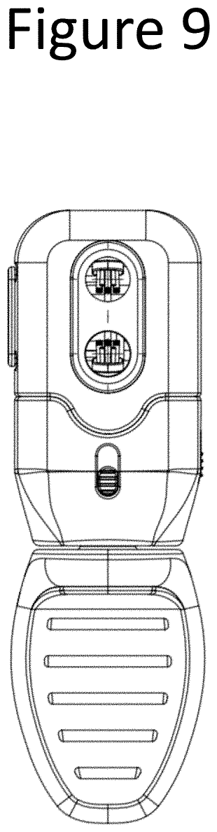

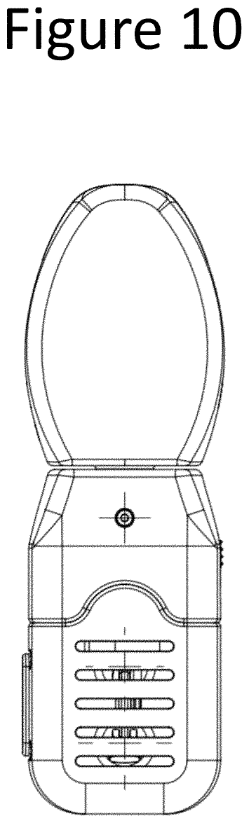

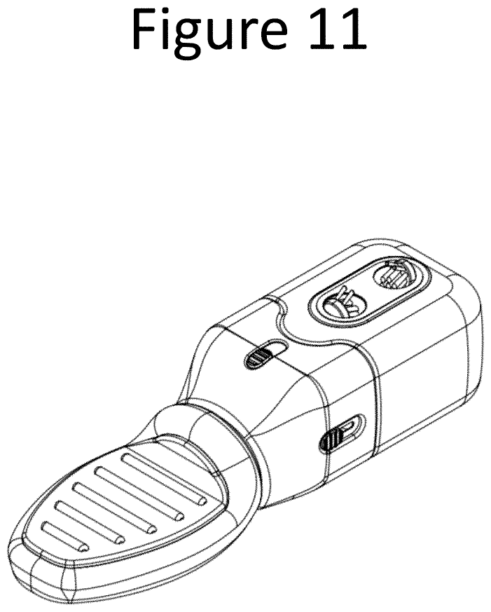

Referring now to FIGS. 5-11, there is illustrated various views of the teeth cleaning appliance of the present inventive concept. In a related embodiment, rechargeable batteries are replaced with standard non-rechargeable batteries. In another related embodiment, the toothbrush heads are individually replaceable and include fading color dyes indicating the time to change the cleaning head. In yet another embodiment, the cleaning appliance is applicable to cleaning dentures or other mouthpieces or removal dental implants or fixtures.

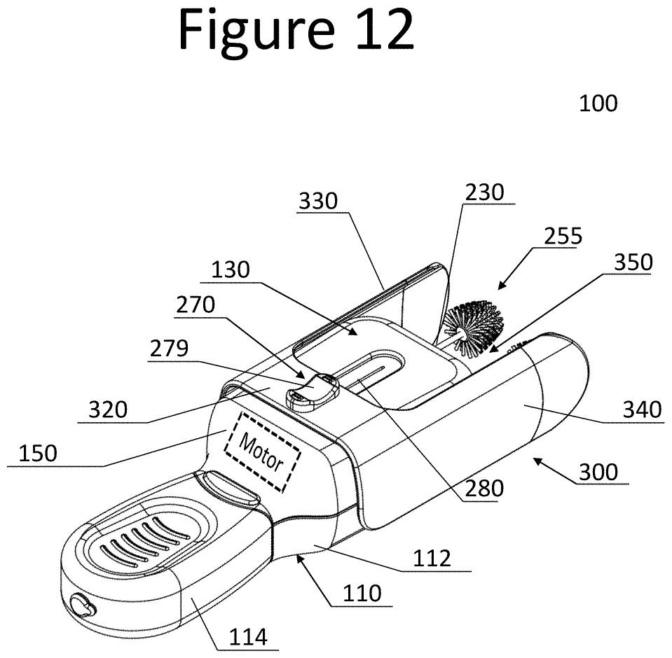

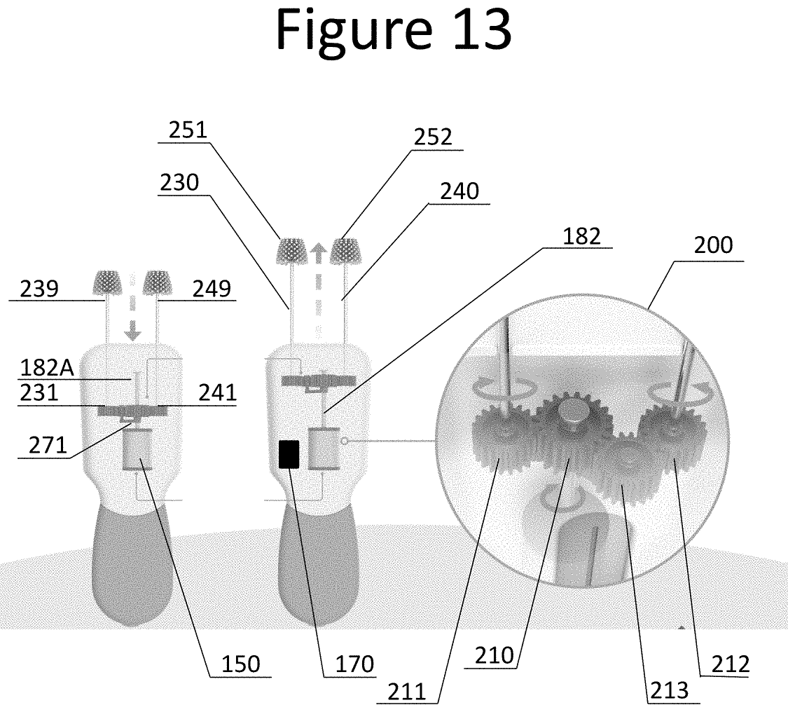

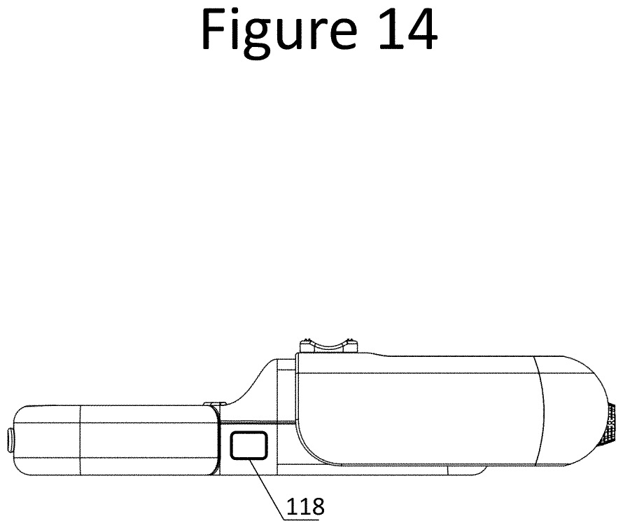

FIGS. 12-14 illustrate the teeth cleaning appliance 100 with the rotating brush configuration with energy generating and transmitting module as a housing and handle assembly 110, the energy transmitting module including a housing 112 and handle 114 having therein a motor 150 and driveshaft assembly 182 electrically connected to a battery 170, the housing including a power actuator 118 located thereon configured to activate and control a speed of the motor 150, wherein the driveshaft 182 includes a proximal drive portion 182A that extends from the motor 150 at an end opposite the handle assembly 114 and which imparts a circular or radial motion upon being actuated. In this embodiment, a teeth brushing module 130 is coupled to the housing member 112. A rotatable drive gear member 210 is disposed within the teeth brushing module 130, the drive gear member 210 axially coupled to the proximal drive portion of the driveshaft 182A. A first brush driveshaft 230 and a second brush driveshaft 240 is disposed parallel and offset to the driveshaft 182 and extends from the teeth brushing module 130 opposite the handle assembly 114. A gear assembly 200 including the rotatable drive gear member 210, a rotatable first brush gear member 211, a rotatable second brush gear member 212, and at least one intermediary gear member 213, each gear member 210, 211, 212, 213 co-planarly aligned and interlocking at least one other gear member 210, 211, 212, 213 within the gear assembly 200. A distal end of the first extendable brush driveshaft 231 is coupled to the rotatable first brush gear member 211, and a distal end of the second brush driveshaft 241 is coupled to the rotatable second brush gear member 212. A first rotatable brush member 251 is coupled to a proximal end of the first brush driveshaft 239 and a second brush member 252 is coupled to a proximal end of the second brush driveshaft 249, a plurality of bristle members 255 circumscribing the first and second brush members 251, 252, wherein the drive gear member 210, when rotated, imparts through the gear assembly 200 a counterrotating movement of the first and second brush members 251, 252 to provide a dual surfaced, rotational tooth cleansing motion on a user's teeth.

In this embodiment of the teeth cleaning appliance 100, the drive gear member 210 is slidably coupled to the driveshaft 182, the drive gear member 210 of the gear assembly 200 coupled to an interior connector assembly 271 of a slider assembly 270, an exterior portion of the slider assembly 279 disposed through a slot portion 280 disposed through the brushing module 130, the slot portion 280 parallel to the driveshaft 182, the slider assembly 270 designed to allow a user to at least partially extend and retract the first and second brush driveshaft 230, 240 from the teeth brushing module 130 by sliding the gear assembly 200 coupled thereto. A U-shaped cheek protector assembly 300 is slidably coupled to the brushing module 130, the aperture portion of the U-shaped cheek protector 350 proximally faced, the first and second brush shaft crank member 230, 240 disposed longitudinally and laterally substantially within the aperture portion 350 and parallel to a first stem portion and a second stem portion 330, 340 of the U-shaped cheek protector 300, the U-shaped cheek protector 300 coupled at the base portion of the U-shaped cheek protector 320 to the exterior portion of the slider assembly 279 and designed to extend and retract jointly with the first and second brush driveshafts 230, 240 attached thereto to the gear assembly 200.

In this exemplary embodiment of the inventive concept, the first brush gear member 211 is co-planar and interlocking with the drive gear member 210, the at least one rotatable intermediary gear member 213 is co-planarly disposed between the drive gear member 210 and the second brush gear member 212 and interlocked with the drive gear member 210 and the second brush gear member 212.

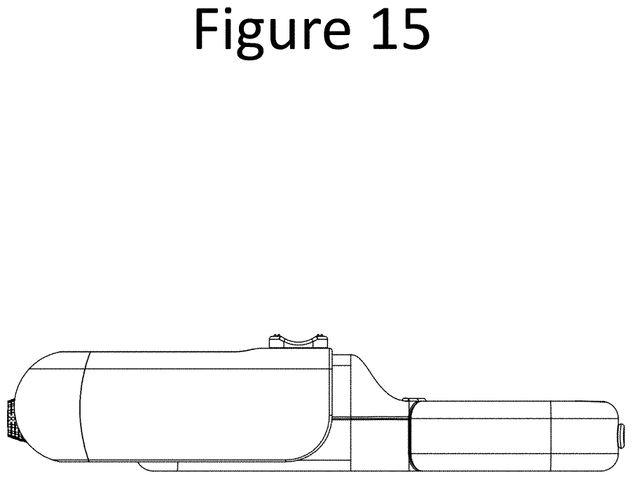

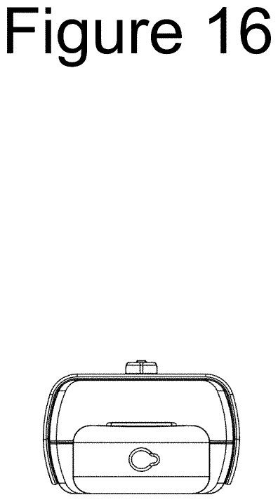

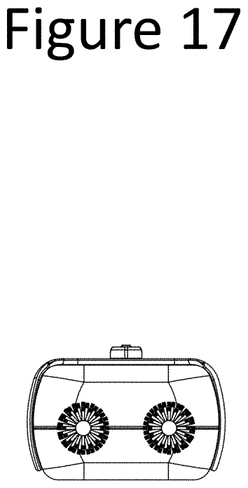

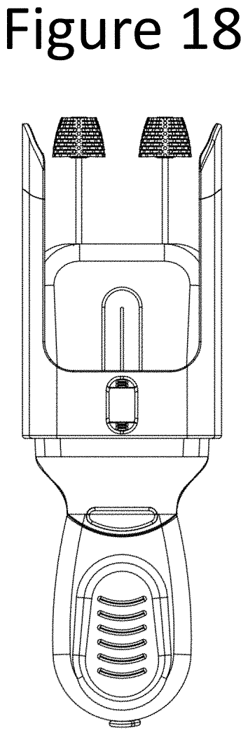

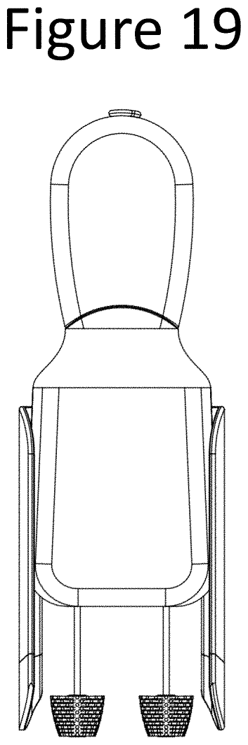

Referring now to FIGS. 15-19, there is illustrated various views of the teeth cleaning appliance of the exemplary embodiments with the rotatable brush configuration.

The following patents are incorporated by reference in their entireties: U.S. Pat. Nos. 5,864,911; 6,381,794, 9,339,357, 9,603,687, and 8,584,292 along with WO2009092958A2, WO2002096314A1, and CN104905887A.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

I claim:

1. A teeth cleaning appliance comprising:
an energy generating and transmitting module and handle assembly, the energy transmitting module including a housing having therein a motor and shaft crank arm assembly electrically connected to a power source, the housing including a power actuator located thereon configured to activate and control a speed of the motor, wherein the shaft crank arm includes a drive portion that protrudes from the module housing at an end opposite the handle assembly and which imparts a circular or radial motion upon being actuated; and
a teeth brushing module coupled to the housing member that includes an L-shaped crank arm that has a proximal end coupled to the drive portion of the shaft crank arm, the teeth brushing module including a dual-head brush assembly protruding from an upper surface of the brushing module and coupled to a distal end of the L-shaped crank arm, wherein the dual-head brush assembly imparts a vertical movement in and out of the brushing module responsive to the L-shaped crank arm movement to provide a dual surface tooth cleansing motion on a user's teeth.

2. The teeth cleaning appliance of claim 1, wherein the dual-head brush assembly within the brushing module includes a set of brush head members partially located within a brush assembly support frame in the housing member, wherein the brush assembly support frame includes a support plate with a set of pivoting stopper arms located on distal ends of the support plate such that the stopper arms form a channel for vertical movement of the set of brush head members, each of the brush head members having spring-like extensions protruding therefrom that are both coupled at a distal end to a spring steel strip, the spring steel strip configured to provide a compression force on the spring-like extensions and against the stopper arms to widen a brush gap between the brush head members with each upward movement of the L-shaped crank arm.

3. The teeth cleaning appliance of claim 2, wherein the teeth brushing module includes a pressure adjustment actuator configured to change the brush gap between the brush head members through a plurality of settings, a low setting for larger teeth wherein the brush head support frame is lowered within the brushing module and a high setting for narrower teeth wherein the brush head support frame is raised within the brushing module and protrudes further from the upper surface of the brushing module.

4. The teeth cleaning appliance of claim 2, wherein the brush head member includes rubber bristles on an upper end configured to massage and clean a user's gums.

5. The teeth cleaning appliance of claim 1, wherein the handle is configured to pivot or rotate axially.

6. The teeth cleaning appliance of claim 1, wherein the teeth brushing module includes a series of fluid draining holes at a surface opposite the brush head members.

7. The teeth cleaning appliance of claim 1, wherein the housing of the energy transmitting module includes a release button to decouple the teeth brushing module from the energy transmitting module.

8. The teeth cleaning appliance of claim 1, wherein the dual-brush head assembly includes head brushes with each having bristles protruding laterally therefrom towards each other to perform a front and rear surface cleaning a user's tooth.

9. The teeth cleaning appliance of claim 1, wherein the handle member includes a ribbed gripping surface.

10. The teeth cleaning appliance of claim 1 wherein the teeth brushing module is configured to be removable from the housing member.

11. The teeth cleaning appliance of claim 1, wherein the housing and handle assembly include a charging port for charging the power source.

12. The teeth cleaning appliance of claim 1 wherein the brush assembly is selected from the group consisting of a set of elongate brush heads, a set of rotary-style bristle brush heads, and a set of elongate sponge heads.

13. The teeth cleaning appliance of claim 1, wherein the handle and housing assembly includes an LED light on an upper surface co-planar with the brush assembly.

14. The teeth cleaning appliance of claim 1, wherein the handle and housing assembly includes an electronic module with a microcontroller to provide time of use alert with a haptic vibration appliance or an LED light.

15. A teeth cleaning appliance comprising:
an energy generating and transmitting module and handle assembly, the energy transmitting module including a housing having therein a motor and driveshaft assembly electrically connected to a power source, the housing including a power actuator located thereon configured to activate and control a speed of the motor, wherein the driveshaft includes a proximal drive portion that extends from the motor at an end opposite the handle assembly and which imparts a circular or radial motion upon being actuated;
a teeth brushing module coupled to the housing member;
a rotatable drive gear member disposed within the teeth brushing module, the drive gear member axially coupled to the proximal drive portion of the driveshaft assembly;
a first brush driveshaft and a second brush driveshaft disposed parallel and offset to the driveshaft and extending from the teeth brushing module opposite the handle assembly;
a gear assembly including the rotatable drive gear member, a rotatable first brush gear member, a rotatable second brush gear member, and at least one intermediary gear member, each gear member co-planarly aligned and interlocking at least one other gear member within the gear assembly;
a distal end of the first extendable brush driveshaft coupled to the rotatable first brush gear member and a distal end of the second brush driveshaft coupled to the rotatable second brush gear member; and
a first rotatable brush member coupled to a proximal end of the first brush driveshaft and a second brush member coupled to a proximal end of the second brush driveshaft, a plurality of bristle members circumscribing the first and second brush members, wherein the drive gear member, when rotated, imparts through the gear assembly a counterrotating movement of the first and second brush members to provide a dual surfaced, rotational tooth cleansing motion on a user's teeth.

16. The teeth cleaning appliance of claim 15, wherein the drive gear member is slidably coupled to the driveshaft assembly, the drive gear member of the gear assembly coupled to an interior connector assembly of a slider assembly, an exterior portion of the slider assembly disposed through a slot portion disposed through the brushing module, the slot portion parallel to the driveshaft, the slider assembly adapted to allow a user to at least partially extend and retract the first and second brush driveshaft from the teeth brushing module.

17. The teeth cleaning appliance of claim 16, wherein a U-shaped cheek protector assembly is slidably coupled to the teeth brushing module, the aperture portion of the U-shaped cheek protector proximally faced, the first and second brush shaft crank member disposed longitudinally and laterally substantially within the aperture portion and parallel to a first stem portion and a second stem portion of the U-shaped cheek protector, the U-shaped cheek protector coupled at the base portion of the U-shaped cheek protector to the exterior portion of the slider assembly and adapted to extend and retract jointly with the first and second brush driveshafts.

18. The teeth cleaning appliance of claim 15, wherein the handle is configured to pivot or rotate axially.

19. The teeth cleaning appliance of claim 15, wherein the housing of the energy transmitting module includes a release button to decouple the teeth brushing module from the energy transmitting module.

20. A method of simultaneously cleaning a front and rear surface of a user's teeth comprising the steps of:
providing a set of opposing brush head members having a plurality of bristles circumscribing the brush head members to form a cleaning zone about the user's teeth; and
counterrotating the opposing brush members in clockwise and counterclockwise directions using a motive force provided by a teeth cleaning mechanism coupled to the brush head members so as to clean a front and back surface of a user's teeth simultaneously, the plurality of bristles adapted to move materials away from the user's gumlines.
